(19) United States
(12) Patent Application Publication
(10) Pub. No.: US 2011/0036830 A1
(43) Pub. Date: Feb. 17, 2011

(54) HEAT TREATING METHOD OF ROLLING BEARING DEVICE FOR WHEEL AND COOLING UNIT FOR INNER SHAFT

(76) Inventors: Hisanobu Nakamura, Nara (JP); Masahei Tachikame, Osaka (JP); Mitsuhiro Inada, Mie (JP); Kunihiro Naganawa, Osaka (JP); Masahiko Oguri, Osaka (JP); Yoshiyuki Minami, Osaka (JP); Naoto Rakawa, Osaka (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/736,614

(22) PCT Filed: Apr. 24, 2009
(86) PCT No.: PCT/JP2009/058162

§ 371 Date: Oct. 22, 2010

(30) Foreign Application Priority Data
Apr. 25, 2008 (JP) 2008-116228

(51) Int. Cl. H05B 6/02

(52) U.S. Cl. 219/600

(57) ABSTRACT

In the heat treating method, a raceway surface of an outer ring is subjected to heat treatment, while an entirety of an outer peripheral face of the outer ring is cooled by injecting water. Moreover, a raceway surface of an inner shaft is subjected to heat treatment, while a flange of the inner shaft is cooled by bringing it into contact with water. The cooling unit has a holding part for holding the flange while the flange is in contact with water.

### TECHNICAL FIELD

The present invention relates to a heat treating method of raceway surfaces of a rolling bearing device for a wheel for rotably supporting the wheel on a suspension of an automobile or the like, and a cooling unit for an inner shaft which is used in the heat treating method.

### BACKGROUND ART

FIG. 1 is a sectional view showing an example of a rolling bearing device 1 for a wheel which has been widely used in recent years. Referring to FIG. 1, the rolling bearing device 1 for a wheel in this example includes an outer ring 2 in a shape of a tube, an inner shaft 3 which is inserted into the tube and coaxially arranged with the outer ring 2, and a plurality of rolling elements 4 which are interposed between the outer ring 2 and the inner shaft 3.

Raceway surfaces 5, 6 in double rows (two rows in the drawing) for supporting the rolling elements 4 so as to roll are formed on an inner periphery of the tube of the outer ring 2. Moreover, on an outer periphery of the tube, a flange 8 having a plurality of projecting parts 7 to be fitted to a suspension, which project outward in a radial direction of the tube from a plurality of positions (only one position is shown in the drawing) in a circumferential direction thereof, is integrally formed with the tube.

On an outer peripheral face of the inner shaft 3, there is formed a raceway surface 13 which is opposed to the raceway surface 5 and supports the rolling elements 4 between them so as to roll. A bearing ring 14 is fitted to the outer periphery of the inner shaft 3 at a position opposed to the raceway surface 6. A raceway surface 15 which is opposed to the raceway surface 6 and supports the rolling elements 4 between them so as to roll is formed on an outer periphery of the bearing ring 14.

A flange 19 to which a wheel, a brake disc and so on are to be fitted is integrally formed on the inner shaft 3 so as to project outward in a radial direction of the inner shaft 3. Moreover, a spigot joint part 21 in a shape of a tube to be engaged with the brake disc is integrally formed on a side face of the flange 19 at an opposite side to a side provided with the raceway surface 13 so as to project from the side face in an axial direction of the inner shaft 3.

The outer ring 2 is produced by applying hot forging work to steel material such as bearing steel, carbon steel for mechanical structure, etc. thereby to form a precursor (a work) of the outer ring, then, by subjecting the raceway surfaces 5, 6 of the work to heat treatment thereby to form a hardened layer having a determined thickness in a region including the raceway surfaces 5, 6, and thereafter, by grinding the surfaces according to necessity. As the heat treatment, a so-called high frequency hardening method in which the raceway surfaces 5, 6 are locally heated by induction heating with a high frequency coil, and thereafter, cooled is employed.

However, the work is in a shape of a thin-walled tube having a wall thickness of about 10 mm or less, and has the raceway surfaces 5, 6 on its inner periphery, and the flange 8 on its outer periphery. Therefore, the wall thickness in an axial direction of the tube is not constant. Moreover, the work has the projecting parts 7 at a plurality of positions in the circumferential direction of the flange, as described above, and therefore, the wall thickness in a circumferential direction of the tube too is not constant. For this reason, there is such anxiety that when the raceway surfaces 5, 6 undergo the heat treatment, a roundness of the tube is deteriorated, for example, and a large distortion may occur in an entirety of the work.

Specifically, because heat of the heat treatment is irregularly transmitted to a region not to be heated of the work due to the above described difference in the wall thickness, irregular expansion occurs in the work and an internal stress is generated. Moreover, the work which has been heated is generally cooled by injecting water like a shower from a number of water injecting ports. However, according to this cooling method, time and amount of the water arriving at the work become different depending on a shape of the work, and the entirety of the work cannot be simultaneously and uniformly cooled. As the results, there is such anxiety that the work is abnormally deformed because of generation of the internal stress and irregular cooling, and a large distortion may occur in the entirety of the work.

Situation is the same with the inner shaft 3. The inner shaft 3 is produced by applying hot forging work to steel material thereby to form a work, which is a precursor of the inner shaft, then, by subjecting the raceway surface 13 of the work to heat treatment thereby to form a hardened layer having a determined thickness in a region including the raceway surface 13, and thereafter, by grinding the surface according to necessity. As the heat treatment, the high frequency hardening method is also employed widely.

Because the brake disc and the wheel are fitted to the side face of the flange 19 at the left side in the drawing, in a state where the spigot joint part 21 is engaged with the brake disc, it is requested for the inner shaft 3 that the side face is as flat as possible and the spigot joint part 21 is not distorted. However, when the raceway surface 13 undergoes the heat treatment, there is such anxiety that the flange 19 may be distorted to deteriorate flatness of the side face and the spigot joint part 21 may be deformed.

Specifically, because heat of the heat treatment is gradually transmitted from a base part of the flange 19, which is adjacent to the raceway surface 13, to a circumferential edge part, irregular expansion occurs between the base part and the circumferential edge part thereby to generate an internal stress. Therefore, there is such anxiety that when water is injected like a shower to cool the work, the flange 19 may be abnormally deformed to be distorted, and the flatness of the side face may be deteriorated. Moreover, when the flange 19 is distorted, the spigot joint part 21 which is integrally formed with the flange 19 is also distorted.

Under the circumstances, it has been conventionally conducted that the work after the heat treatment and before grinding is subjected to a turning process to correct the distortion, for the purpose of obtaining dimensional accuracy required for the outer ring 2, or enhancing the flatness of the side face of the flange 19 of the inner shaft 3, and correcting distortion of the spigot joint part 21. However, in this method, working steps are increased, because the turning process is required, and there is such a problem that productivity of the outer ring 2, the inner ring 3, and accordingly, the rolling bearing device 1 for a wheel may be deteriorated. Moreover, considering an amount of turning after the heat treatment, and for the purpose of restraining occurrence of the distortion by the heat treatment to the least, it is necessary to make the work rather thick. Therefore, there is another problem that quantity of the steel material which is required for producing the outer ring 2 and the inner shaft 3, energy required for transportation, space required for storage, etc. are increased.

In addition, there is such anxiety that in case where the heat of the heat treatment is irregularly transmitted to the region not to be heated of the work or the work is irregularly cooled, hardening irregularity may occur. Specifically, a thickness of the hardened layer which is formed by the heat treatment in a direction of depth and its spread in a direction of surface may be varied. Particularly, in the outer ring 2, the hardened layer may reach the outer peripheral face of the tube, and the outer peripheral face may be irregularly discolored, in some cases.

It has been proposed to restrain distortion of the work, by preparing two concentric rings respectively having engaging parts to be engaged with openings of the tube of the outer ring, and by heat treating the engaging parts of the respective concentric rings in a state engaged with the openings at both sides of the tube of the outer ring.

### PRIOR ART DOCUMENT

### Patent Document

[Patent Document 1]

Japanese Patent Publication No. JP-A-S59-226118

### SUMMARY OF THE INVENTION

### Problems that the Invention is to Solve

However, effect of preventing deformation by the concentric rings is not yet sufficient, and the work is still likely to be deformed by the heat treatment. Therefore, the step of turning the work to correct the distortion cannot be completely omitted. Moreover, the cooling is conducted by injecting water to the work in the same manner as in the conventional case, and so, occurrence of hardening irregularity cannot be restrained. Additionally, it is not at all taken into consideration, in the above described Patent Document 1, to prevent distortion of the flange of the inner shaft.

The invention has been made in view of such background, and an object of the invention is to provide a heat treating method of a rolling bearing device for a wheel in which an outer ring and an inner shaft having required dimensional accuracy can be formed, without further applying a turning process to the work after the heat treatment, and without generating hardening irregularity. It is another object of the invention to provide a cooling unit for the inner shaft which is used in the heat treating method.

### Means for Solving the Problems

In order to attain the above described object, there is provided, according to the invention, a heat treating method of raceway surfaces of a rolling bearing device 1 for a wheel comprising,

an outer ring (2) in a shape of a tube having a raceway surface (5, 6) formed on its inner periphery, and

an inner shaft (3) coaxially arranged with the outer ring, and integrally provided with an outer peripheral face having a raceway surface (13) and a flange (19) to which the wheel is fitted,

characterized in that when the raceway surfaces are heated to form hardened layers, the raceway surfaces which are heated and adjacent regions are continuously cooled with water, for a determined period during the heating and after the heating (Claim 1). It is to be noted that numerals in parenthesis represent corresponding constituent elements and so on in an embodiment which will be described below.

According to the invention, the raceway surface of the outer ring or the inner shaft which is heated and the adjacent region are continuously cooled with water, for a determined period both during the heating and after the heating. Therefore, in case of the outer ring, it is possible to restrain generation of an internal stress in the outer ring due to irregular transmission of the heat of the heat treatment to the region not to be heated. Moreover, an entirety of the outer ring can be simultaneously and uniformly cooled, only by stopping the heating.

As the results, abnormal deformation of the outer ring by the heat treatment and occurrence of a large distortion in its entirety can be prevented. Accordingly, it becomes possible to obtain dimensional accuracy required for the outer ring, even though a step of further turning the outer ring after the heat treatment to correct the distortion is omitted.

In case of the inner shaft, because the flange is uniformly cooled, occurrence of distortion of the flange due to internal stress, and accompanying distortion of the spigot joint part can be restrained. As the results, it becomes possible to obtain flatness required for the side face and to obtain dimensional accuracy of the spigot joint part, even though a step of further turning the side face and the spigot joint part to correct the distortion is omitted.

Therefore, productivity of the outer ring, the inner shaft, and accordingly, the rolling bearing device for a wheel can be enhanced, because the turning step can be omitted. Moreover, necessity of forming works, which are precursors of the outer ring and the inner shaft, rather larger considering an amount to be turned after the heat treatment is eliminated, and therefore, quantity of steel material required for producing the outer ring and the inner shaft, energy required for transportation, space required for storage, etc. can be decreased.

Further, occurrence of hardening irregularity is restrained, and so, thickness and spread of the hardened layer which is formed by the heat treatment can be made uniform. In addition, particularly in the outer ring, it is also possible to prevent such phenomenon that the hardened layer partially reaches the outer peripheral face of the tube to irregularly discolor the outer peripheral face.

Considering that the raceway surface of the outer ring is to be heat treated as uniformly as possible, it would be preferable that a high frequency coil (28) for induction heating is inserted into the outer ring in a shape of a tube so as to be opposed to the raceway surface on the inner periphery, then, the outer ring is relatively rotated with respect to the high frequency coil in a circumferential direction around an axis (A) of the tube, at the same time, the high frequency coil is energized thereby to heat the raceway surface, while an entirety of the outer peripheral face of the outer ring is cooled by injecting water (27), and the cooling is continuously conducted for a certain time after the heating is finished (Claim 2).

Further, considering that the raceway surface of the inner shaft is to be heat treated as uniformly as possible, while occurrence of distortion in the flange and the spigot joint part is prevented to the least, it would be preferable that a high frequency coil (41) for induction heating is provided so as to be opposed to the raceway surface of the inner shaft, then, the inner shaft is relatively rotated with respect to the high frequency coil in a circumferential direction around an axis of the inner shaft, at the same time, the high frequency coil is energized thereby to heat the raceway surface, while the flange of the inner shaft is cooled by bringing it into contact with water (27), and the cooling is continuously conducted for a certain time after the heating is finished (Claim 3).

According to the invention, there is provided a cooling unit (31) for an inner shaft of a rolling bearing device for a wheel which is integrally provided with an outer peripheral face having a raceway surface and a flange to which a wheel is fitted, characterized in that the cooling unit includes a holding part (32) which holds the inner shaft in a state where the outer peripheral face having the raceway surface is positioned above while the flange is positioned below, and can be rotated in a circumferential direction around an axis of the inner shaft which is held, and the holding part has a flow passage of water which supplies the water to a side face at a lower side of the flange which is held thereby to cool the flange, by bringing the water into contact with the side face, and thereafter, allows the water to be discharged to the exterior (Claim 4).

According to the invention, the raceway surface is heated by induction heating, for example, and thereafter, cooled, while the holding part holding the inner shaft is rotated around the axis of the inner shaft which is held, and the water is circulated through the flow passage to cool the flange. In this manner, it is possible to subject the raceway surface to heat treatment, while restraining deformation of the flange and the spigot joint part.

### BRIEF DESCRIPTION OF THE DRAWINGS

FIG. 1 is a sectional view showing an example of a rolling bearing device for a wheel which is produced through heat treating method according to the invention.

FIG. 2 is a sectional view showing an example of a heat treating step of an outer ring in the heat treating method according to the invention.

FIG. 3 is a sectional view showing an example of a heat treating step of an inner shaft in the heat treating method according to the invention.

### MODE FOR CARRYING OUT THE INVENTION

Referring to the drawings, an embodiment of the invention will be specifically described below.

FIG. 1 is a sectional view showing an example of a rolling bearing device 1 for a wheel, as described above. Referring to FIG. 1, the rolling bearing device 1 for a wheel includes an outer ring 2 in a shape of a tube, an inner shaft 3 which is inserted into the tube and coaxially arranged with the outer ring 2 around an axis A, and a plurality of rolling elements 4 which are interposed between the outer ring 2 and the inner shaft 3.

Raceway surfaces 5, 6 in double rows (two rows in the drawing) for supporting the rolling elements 4 so as to roll are formed on an inner periphery of the tube of the outer ring 2. Moreover, a flange 8 having a plurality of projecting parts 7 to be fitted to a suspension is integrally formed with the tube on an outer periphery thereof so as to project outward in a radial direction of the tube from a plurality of positions (only one position is shown in the drawing) in a circumferential direction of the tube. The flange 8 is provided with screw holes 9 passing it through in an axial direction of the tube, and bolts (not shown) for fitting the flange 8 to the suspension are adapted to be screwed into the screw holes 9.

The inner shaft 3 includes a large diameter part 10 having a larger outer diameter, a middle diameter part 11 having an outer diameter smaller than the large diameter part 11, and a small diameter part 12 having an outer diameter smaller than the middle diameter part 11, which are integrally formed so as to be coaxial in order from one end side (the left side in the drawing) to the other end side (the right side) in a direction of the axis A. A raceway surface 13 opposed to the raceway surface 5 is formed in a step difference part between the large diameter part 10 and the middle diameter part 11. Moreover, a bearing ring 14 is fitted to the small diameter part 12, and a raceway surface 15 opposed to the raceway surface 6 is formed on an outer periphery of the bearing ring 14.

The bearing ring 14 is in a shape of a tube consistent with the outer diameter of the small diameter part 12, and includes a small diameter part 16 having a smaller outer diameter, and a large diameter part 17 having an outer diameter larger than the small diameter part 16, which are integrally formed so as to be coaxial in order from one end side to the other end side in the direction of the axis A. The raceway surface 15 is formed in a step difference part between the small diameter part 16 and the large diameter part 17 so as to be opposed to the raceway surface 13.

Before the rolling bearing device 1 for a wheel is assembled, an end part 18 of the small diameter part 12 of the inner shaft 3 is formed in a shape of a tube having the same diameter as the small diameter part 12, as shown by a dotted line in the drawing.

In order to assemble the rolling bearing device 1 for a wheel, the bearing ring 14 is fitted to the small diameter part 12 in a state where the determined numbers of the rolling elements 4 are respectively held between the raceway surfaces 5 and 13 and between the raceway surfaces 6 and 15, and the one end side of the bearing ring 14 is in contact with the step difference part between the middle diameter part 11 and the small diameter part 12.

Then, by caulking the end part 18, as shown by a solid line in the drawing, the bearing ring 14 is fixed to the inner shaft 3 thereby to assemble the rolling bearing device 1 for a wheel. In this manner, a double row thrust angular ball bearing is composed of the rolling elements 4, the raceway surfaces 5, 6, and the raceway surfaces 13, 15, and the inner shaft 3 is supported with respect to the outer ring 2 so as to rotate around the axis A.

A flange 19 for fixing a wheel, a brake disc and so on is integrally formed on an outer periphery at one end side of the large diameter part 10 of the inner shaft 3 so as to project outward in the radial direction from the outer periphery. Bolts 20 for securing the wheel and brake disc, which are not shown, are provided on the flange 19 at a plurality of positions (only one position is shown in the drawing) in the circumferential direction. Moreover, a spigot joint part 21 in a tubular shape to be engaged with the brake disc is integrally formed on a side face of the flange 19 at the one end side thereof so as to project from the side face to the one end side.

The outer ring 2 out of the respective parts is produced in the same manner as in the conventional case, by applying hot forging work to steel material such as bearing steel, carbon steel for mechanical structure, etc. to be formed into a shape as shown in FIG. 1, then, by subjecting the raceway surfaces 5, 6 to heat treatment thereby to form a hardened layer having a determined thickness in a region including the raceway surfaces 5, 6, and thereafter, by grinding the surfaces according to necessity.

Moreover, the inner shaft 3 is also produced in the same manner as in the conventional case, by applying hot forging work to steel material to be formed into a shape as shown in FIG. 1, then, by subjecting the raceway surface 13 to heat treatment thereby to form a hardened layer having a determined thickness in a region including the raceway surface 13, and thereafter, by grinding the surface according to necessity.

In this case, the heat treating method of the rolling bearing device for a wheel according to the invention is different from the prior art in that on occasion of the heat treatment of the outer ring 2 and/or the inner shaft 3, regions adjacent to the raceway surfaces 5, 6, 13 which are being heated are cooled with water for a determined time during heating and after heating.

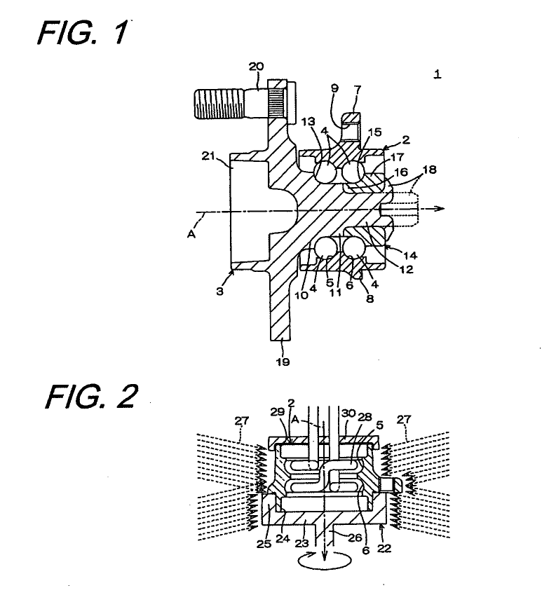

FIG. 2 is a sectional view showing an example of a heat treating step of the outer ring 2 in the heat treating method of the rolling bearing device for a wheel according to the invention. Referring to FIG. 2, a turntable 22 which rotates and holds the outer ring 2 is prepared, in this example.

The turntable 22 includes a base plate 23 to be contacted with an end face of the outer ring 2 at the other end side thereof (a lower side in the drawing), a projecting part 25 which is integrally formed on a peripheral edge of the base plate 23 and engaged with the outer periphery of the outer ring 2 at the other end side to close an opening 24 at the other end side in cooperation with the base plate 23, and a rotation shaft 26 which is fitted to a lower face of the base plate 23. The projecting part 25 and the rotation shaft 26 are provided coaxially so that the axis A of the tube of the outer ring 2 is consistent with a center axis of the rotation shaft 26, in a state where the projecting part 25 is engaged with the other end side of the outer ring 2.

Then, a high frequency coil 28 for induction heating is inserted into the tube of the outer ring 2 which is held by the turntable 22, in a state where the outer ring 2 is engaged with the projecting part 25 and its end face is in contact with an upper face of the base plate 23. As the high frequency coil 28, such a high frequency coil that its winding diameter is set to be a diameter capable of being inserted into the tube of the outer ring 2 and to be as close as possible to the raceway surfaces 5, 6, and at the same time, the number of windings in the direction of the axis A is double windings corresponding to the number of the rows (two rows) of the raceway surfaces 5, 6, and an interval of the windings is consistent with an interval where the raceway surfaces 5, 6 are formed is used. The high frequency coil 28 is connected to a high frequency power supply which is not shown.

The high frequency coil 28 is provided with a lid body 30 which is covered on an opening 29 of the outer ring 2 at the one end side (an upper side in the drawing), in a state where the double winding part is opposed to the raceway surfaces 5, 6, thereby to close the opening 29. In this manner, the openings 24 and 29 at the other end side and at the one end side of the outer ring 2 are closed with the turntable 22 and the lid body 30 so that intrusion of water 27 into a space in the tube of the outer ring 2 can be prevented.

Then, in a state where the high frequency coil 28 is fixed so as not to rotate around the axis A or to move in a vertical direction, the water 27 is injected to an outer peripheral face of the outer ring 2 from an outer circumferential jacket, which is not shown, as shown by arrow marks of dotted lines in the drawing. At the same time, a high frequency current is inputted into the high frequency coil 28, while the turntable 22 is rotated in one direction as shown by an arrow mark of a solid line. Consequently, the raceway surfaces 5, 6 and the adjacent regions opposed to the high frequency coil 28 in the outer ring 2 which is held on the turntable 22 are subjected to induction heating.

Additives such as water-soluble high polymer may be added to the water 27, according to necessity.

Temperature of the induction heating is set to be such a temperature that the steel material forming the aforesaid region of the outer ring 2 may present austenite phase, as commonly known. In case where the outer ring 2 is cooled after a certain time has passed after arriving at the temperature, the steel material forming the region is hardened by martensite transformation.

On this occasion, according to the invention, an entirety of the outer peripheral face of the outer ring 2 is continuously cooled by injecting the water 27 during the heat treatment. Therefore, it is possible to restrain occurrence of an internal stress in the outer ring 2 due to irregular transmission of the heat to the region not to be heated. Moreover, it is possible to cool the entirety of the outer ring 2 simultaneously and uniformly, by continuously injecting the water 27 for a certain time, even after the heating is stopped.

As the results, it is possible to prevent the outer ring 2 from being remarkably distorted in its entirety due to abnormal deformation by the heat treatment. Accordingly, it becomes possible to obtain the dimensional accuracy required for the outer ring 2, even though the step of further turning the outer ring 2 after the heat treatment to correct the distortion is omitted. Therefore, productivity of the outer ring 2, and accordingly, of the rolling bearing device 1 for a wheel can be enhanced, because the step can be omitted. Moreover, the necessity of making the work, which is the precursor of the outer ring 2, rather larger, considering an amount to be turned after the heat treatment is eliminated, and therefore, quantity of the steel material required for producing the outer ring 2, energy required for transportation, space required for storage and so on can be decreased.

Further, occurrence of hardening irregularity is restrained, and so, thickness and spread of the hardened layer which is formed by the heat treatment can be made uniform. In addition, it is also possible to prevent such phenomenon that the hardened layer partially reaches the outer peripheral face of the tube thereby to irregularly discolor the outer peripheral face.

After the heat treatment, the outer ring 2 is dried according to necessity, and then, assembled with the rolling elements 4, the inner shaft 3, and the bearing ring 14 in the above described steps, thereby to produce the rolling bearing device 1 for a wheel as shown in FIG. 1.

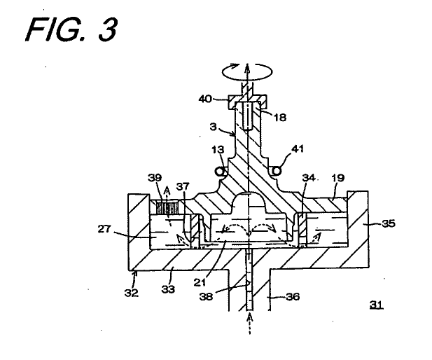

FIG. 3 is a sectional view showing an example of a heat treating step of the inner shaft 3 in the heat treating method of the rolling bearing device for a wheel according to the invention, using an example of a cooling unit according to the invention.

Referring to FIG. 3, a cooling unit 31 which is used in this example, includes a holding part 32 which holds the inner shaft 3 in a state where the outer peripheral face having the raceway surface 13 is positioned above and the flange 19 is positioned below, and can rotate in a circumferential direction around the axis A of the inner shaft 3.

The holding part 32 includes a bottom plate 33, and a receiving part 34 in a shape of a tube which is projected upward from an upper face of the bottom plate 33, and contacted with the side face of the flange 19 at a lower side in the drawing, thereby to hold the flange 19, leaving a clearance between the flange 19 and the bottom plate 33. The receiving part 34 is so set that an inner diameter of the tube is larger than the outer diameter of the spigot joint part 21, and a projecting height from the upper face of the bottom plate 33 is higher than a height of the spigot joint part 21 in the direction of the axis A. Therefore, in a state where the flange 19 is held by the receiving part 34, the spigot joint part 21 is inserted into the tube of the receiving part 34 and held, leaving a clearance between the spigot joint part 21 and the bottom plate 33.

Moreover, the holding part 32 includes a projecting part 35 in a tubular shape which is integrally formed on a peripheral edge of the bottom plate 33 to be contacted with the outer periphery of the flange 19 which is held by the receiving part 34, and partitions the clearance between the flange 19 and the bottom plate 33 from an outside, and a rotation shaft 36 which is fitted to a lower face of the bottom plate 33.

The projecting part 35 and the rotation shaft 36 are coaxially provided so that the axis A of the inner shaft 3 may be consistent with a center axis of the rotation shaft 36, in a state where the projecting part 35 is in contact with the outer periphery of the flange 19. Moreover, a though hole 37 communicating an interior of the tube with the exterior is formed in a base part of the receiving part 34, and a though hole 38 communicating the upper face of the bottom plate 33 with water supplying means, which is not shown, is formed in the rotation shaft 36. In this manner, a flow passage of the water 27 up to a spline hole 39 of the flange 19 to which the bolt 20 is fitted is formed by way of the through hole 38, the interior of the tube of the receiving part 34, the clearance between the spigot joint part 21 and the bottom plate 33, the through hole 37, and the exterior of the tube of the receiving part 34.

A receiving member 40 for preventing shaft runout is mounted on the upwardly projected end part 18 of the inner shaft 3 which is held by the holding part 32, so as to rotate around the axis A in a state engaged with the end part 18. At the same time, a high frequency coil 41 for induction heating is inserted over the inner shaft 3. As the high frequency coil 41, such a high frequency coil that its winding diameter is set to be a diameter capable of being inserted over the inner shaft 3 and to be as close as possible to the raceway surface 13, and at the same time, the number of windings in the direction of the axis A is single winding corresponding to the number of the rows of the raceway surface 13 (one row) is employed. The high frequency coil 41 is connected to a high frequency power supply which is not shown.

Then, in a state where the high frequency coil 41 is fixed so as not to rotate around the axis A or to move in the vertical direction, the water 27 is continuously supplied from the water supply means, which is not shown, through the flow passage thereby to cool the flange 19, and the water 27 is allowed to overflow to the exterior through the spline hole 39. At the same time, high frequency current is inputted to the high frequency coil 41, while the holding part 32 is rotated in one direction, as shown by a solid line in the drawing. In this manner, the raceway surface 13 opposed to the high frequency coil 41 and the region adjacent to the raceway surface 13 in the inner shaft 3 which is held on the holding part 32 is subjected to the induction heating.

Temperature of the induction heating is set to be such temperature that the steel material forming the aforesaid region of the inner shaft 3 may present austenite phase. In case where the inner shaft 3 is cooled after a certain time has passed after arriving at the temperature, the steel material forming the aforesaid region is hardened by martensite deformation.

On this occasion, in the embodiment in the drawings, because both the flange 19 and the spigot joint part 21 of the inner shaft 3 are continuously cooled with the water 27 which is continuously supplied through the flow passage, occurrence of distortion of the flange 19 due to the internal stress and accompanying distortion of the spigot joint part 21 can be restrained. As the results, it becomes possible to obtain the flatness required for the side face of the flange 19 and the dimensional accuracy of the spigot joint part 21, even though the step of correcting the distortions by further turning the side face of the flange 19 and the spigot joint part 21 after the heat treatment is omitted.

Therefore, the productivity of the inner shaft 3 and accordingly, of the rolling bearing device 1 for a wheel can be enhanced, because the aforesaid step can be omitted. Moreover, necessity of forming the work, which is the precursor of the inner shaft 3, rather larger considering an amount to be turned after the heat treatment is eliminated, and therefore, quantity of the steel material required for producing the inner shaft 3, energy required for transportation, space required for storage, etc. can be decreased. Moreover, occurrence of hardening irregularity is restrained, and so, the thickness and spread of the hardened layer which is formed by the heat treatment can be made uniform.

After the heat treatment, the inner shaft 3 is dried according to necessity, and thereafter, the rolling elements 4, the outer ring 2, and the bearing ring 14 are combined and assembled thereby to produce the rolling bearing device 1 for a wheel as shown in FIG. 1. On this Occasion, the outer ring 2 after the heat treatment as shown in FIG. 2 and the inner shaft 3 after the hardening treatment as shown in FIG. 3 may be combined. In this case, the productivity of the rolling bearing device 1 for a wheel can be further enhanced.

The invention is not limited to the above described embodiment, but various modifications can be made within a scope described in the claims. For example, although the high frequency coil 28 is fixed and the outer ring 2 is rotated to conduct the heat treatment, in FIG. 2, it is possible to fix the outer ring 2 and to rotate the high frequency coil 28 to conduct the heat treatment, to the contrary. Alternatively, it is possible to rotate both the outer ring 2 and the high frequency coil 28 to conduct the heat treatment. In the latter case, rotation direction and rotation speed of both the outer ring 2 and the high frequency coil 28 may be made different so that they can rotate relatively to each other.

Similarly, although the high frequency coil 41 is fixed and the inner shaft 3 is rotated to conduct the heat treatment, in FIG. 3, it is possible to fix the inner shaft 3 and to rotate the high frequency coil 41 to conduct the heat treatment, to the contrary. Alternatively, it is possible to rotate both the inner shaft 3 and the high frequency coil 41 to conduct the heat treatment.

Moreover, the rolling bearing device for a wheel which is produced according to the invention is not limited to the one as shown in FIG. 1, but may be, such a rolling bearing device that raceway surfaces in double rows are formed in a bearing ring which is a separate body from the inner shaft 3 as in the conventional case. Alternatively, the rolling bearing device for a wheel according to the invention may be such a rolling bearing device that both raceway surfaces in double rows are directly formed on the outer peripheral face of the inner shaft 3, which currently undergoes development. It is possible to conduct heat treatment of the raceway surfaces, in a state where the outer ring in which the raceway surfaces are optionally arranged according to arrangement of the raceway surfaces of the inner shaft is soaked in water.

1. A heat treating method of raceway surfaces of a rolling bearing device for a wheel comprising,
an outer ring in a shape of a tube having a raceway surface formed on an inner periphery thereof, and
an inner shaft coaxially arranged with the outer ring, and integrally provided with an outer peripheral face having a raceway surface and a flange to which a wheel is fitted,
wherein, when the raceway surfaces are heated to form hardened layers, the raceway surfaces which are heated and adjacent regions are continuously cooled with water, for a determined time during the heating and after the heating.

2. A heat treating method of a rolling bearing device for a wheel as claimed in claim 1, wherein, in a state where a high frequency coil for induction heating is inserted into the outer ring in a shape of a tube so as to be opposed to the raceway surface on the inner periphery, the outer ring is relatively rotated with respect to the high frequency coil in a circumferential direction around an axis of the tube, the high frequency coil is energized thereby to heat the raceway surface, while an entirety of the outer peripheral face of the outer ring is cooled by injecting water, and the cooling is continuously conducted for a certain time after the heating is finished.

3. A heat treating method of a rolling bearing device for a wheel as claimed in claim 1, wherein a high frequency coil for induction heating is provided so as to be opposed to the raceway surface of the inner shaft, the inner shaft is rotated relatively with respect to the high frequency coil in a circumferential direction around an axis of the inner shaft, the high frequency coil is energized thereby to heat the raceway surface, while the flange of the inner shaft is cooled by bringing into contact with water, and the cooling is continuously conducted for a certain time after the heating is finished.

4. A cooling unit for an inner shaft of a rolling bearing device for a wheel which is integrally provided with an outer peripheral face having a raceway surface and a flange to which a wheel is fitted, characterized in that the cooling unit includes a holding part which holds the inner shaft in a state where the outer peripheral face having the raceway surface is positioned above while the flange is positioned below, and can be rotated in a circumferential direction around an axis of the inner shaft which is held, and the holding part has a flow passage of water which supplies the water to a side face at a lower side of the flange which is held, thereby to cool the flange by bringing the water into contact with the side face, and thereafter, allows the water to be discharged to the exterior.
